(19) United States
(12) Patent Application Publication
(10) Pub. No.: US 2002/0168060 A1
(43) Pub. Date: Nov. 14, 2002

(54) Method for detecting and preventing call forwarding events

(76) Inventor: David L. Huie, Merritt Island, FL (US)

Correspondence Address: MCKENNA LONG & ALDRIDGE LLP, 1900 K STREET, NW, WASHINGTON, DC, 20006, US

(21) Appl. No.: 09/852,732

(22) Filed: May 11, 2001

(51) Int. Cl. H04M 3/42; H04M 15/00; H04M 3/00

(52) U.S. Cl. 379/211.02; 379/114.14; 379/188

(57) ABSTRACT

Call forwarding can be used to commit fraud or to evade security controls in inmate calling systems. Information from the Common Channel Signaling (CCS) network can be used to detect when a dialed number has been call forwarded and furthermore prevent the call forwarding event from occurring. It is possible to determine whether a dialed number has been call forwarded by setting up a call to that number with the Redirection Counter in the Initial Address Message set to the maximum value allowed in the signaling system being utilized (e.g., CCS7). If the terminating switch fails to set up the call even though the trunk is available, the assumption is made that the call is call forwarded. A second attempt is then made to set up the call a second time setting the Redirection Counter in the Initial Address Message to zero. If the terminating switch returns an Answer Complete Message indicating that the call has been successfully set up, then it has been demonstrated that the dialed number is call forwarded. This information can then be used to terminate the call attempt to the forwarded number, or alternatively, a variety of fraud prevention and/or fraud tracking processes can be initiated. Call forwarding events can be detected without the use of a telecommunications switch through which the call must pass.

### BACKGROUND OF THE INVENTION

1. Field of the Invention

The present invention relates to call processing, and particularly relates to detection and prevention of calling a telephone number that has been call forwarded to another telephone number.

2. Discussion of the Related Art

Call forwarding is a telephone feature which allows a customer to direct a communications network to re-route telephone calls from one location to another location. Specifically, calls placed to a dialed number are re-routed to a telephone station identified by a different telephone number, which is specified by the customer when setting up the call forwarding feature. Call forwarding, however, is susceptible to various telecommunications fraud schemes. In particular, persons attempting to defraud the telephone company (referred to hereafter as “hackers”) subscribe, either legitimately or fraudulently, to telephone service with call forwarding as a service feature. The hackers then arrange to place calls to telephone numbers using the call forwarding feature, which would otherwise be blocked by the network.

Hackers often have pecuniary motives for committing call forwarding fraud. For example, in a prison environment, an inmate may call a local number that is forwarded to a long distance number thereby avoiding the higher long distance rates charged by the inmate telephone service provider. However, hackers may also wish to avoid some security control imposed on their use of the telephone network. Again, in a prison environment, the correctional authorities may limit an inmate's calls to a list of authorized list of telephone numbers (an “allow list”). The inmate may circumvent this security restriction by calling an authorized telephone number that has been call forwarded to an unauthorized number.

Current methods for protecting and preventing unauthorized use of the communications network have not adequately addressed the problem. For example, methods which detect fraud based on data obtained at the end of one or more billing cycles do not provide sufficiently timely information. By the time the information becomes available to indicate fraud, large amounts of fraudulent usage could already have occurred. Operator-assisted calls involve further difficulties in detecting and blocking fraud because anti-fraud protections may be bypassed.

Current methods that utilize data from the communications signaling network are also inadequate. Determining whether a number is call forwarded by looking at the Call Forwarding Indicator in the call setup message (Initial Address Message) is not reliable because of the inconsistent use of that particular parameter. Attempts to compare the dialed number with the connect number returned in a Call Progress Group (CPG) message will often fail, because Local Exchange Carrier (LEC) switches do not consistently return CPG messages as a result of a call forwarding event.

The providers of Inmate Telephone Systems (ITS), highly specialized phone systems used to provide telephone services to inmates in correctional institutions (prisons, jails, penitentiaries, etc.), have gone to great lengths to develop systems that prevent inmates from calling unauthorized telephone numbers. Inmates frequently attempt to call unauthorized numbers for three reasons: (1) to harass/threaten victims of their crimes, potential witnesses, judges, prosecuting attorneys, etc.; (2) to pursue illicit activities (e.g., drug trafficking); (3) to avoid long distance charges by calling a local phone number which is either forwarded to a long distance number or on which a second call is conferenced (three-way call conference) to a long distance number.

Efforts to prevent inmates from calling unauthorized numbers have by and large focused on preventing three-way call conferencing, that is, the use of either a second telephone line or a Centrex service (a service provided by the Local Exchange Carrier from its central office switch) to conference the inmate's call with a second call to an unauthorized number. U.S. Pat. No. 6,141,406 to Johnson, U.S. Pat. No. 5,926,533 to Gainsboro, U.S. Pat. No. 5,883,945 to Richardson, Jr., et al., U.S. Pat. No. 5,805,685 to McFarlen, U.S. Pat. No. 5,796,811 to McFarlen, U.S. Pat. No. 5,768,355 to Salibrici, et al., U.S. Pat. No. 5,745,558 to Richardson, Jr., et al., U.S. Pat. No. 5,539,812 to Kitchin, et al., and U.S. Pat. No. 5,319,702 to Kitchin et al. are all intended to detect and prevent calls to unauthorized numbers using three-way call conferencing methods.

Such methods do not address the possibility that the caller (the inmate) may call an authorized number that is automatically forwarded to an unauthorized number. Since call forwarding does not require a three-way call conference in order for the caller to be connected to an unauthorized number, other methods must be used to detect and prevent a call forwarding event.

One U.S. Pat. No. 5,615,253 to Kocan, et al., does attempt detection of a call forwarding event using one of two methods. First, a communications company may determine that a call is forwarded by examining the Call Forwarding Indicator, parameters 3.21 or 3.25 of the ISUP (ISDN User's Part) Call Progress Group (CPG) message, that is supposed to indicate whether a call has been forwarded or not. The patent itself recognizes that this method of detecting call forwarding events does not work consistently because terminating switches frequently do not set the Call Forwarding Indicator in the CPG message even when the dialed number is call forwarded.

This same patent offers a second solution for detecting a call forwarding event. Should the Call Forwarding Indicator not be available, a communications company may compare the dialed telephone number and the “connect number” (the number to which the call is to be forwarded if call forwarding indeed occurs) and, if the two telephone numbers are different, a call forwarding event would be assumed to be in process. The patent states that “the dialed number and the connect number are captured by various components of the signaling network at various times during call set up.”

While such an assertion sounds good in theory, in practice, this method contains such a large loophole as to be frequently ineffective. The key assumption is that the LEC switch to which the dialed (i.e., the call forwarded) number is connected will send the originating switch a Call Progress Group message.

In practice, this often does not happen. U.S. Pat. No. 5,615,253 relies heavily on consistent application by the LECs of the CCS7 (Signalling System 7) standard, namely the use of the Call Forwarding Indicator and Call Progress Group messages. One skilled in the art would acknowledge that such reliance greatly reduces the effectiveness of this patent's methods for detecting and preventing call forwarding events.

Finally, U.S. Pat. No. 5,615,253 appears to require the use of a switch through which the call to the dialed number will be processed. If the call is not routed to said switch, then the call forwarding event would never be detected. For example, if the originating number (the number from which the call is made), the dialed number (the number that the originating station wishes to call), and the connect number (the number to which the dialed number is forwarded) were all connected to the same LEC switch, it is not apparent how the call forwarding detection method described in U.S. Pat. No. 5,615,253 would work. In other words, if the call does not pass through a switch utilizing the patent's method for comparing the dialed number and the connect number, it is not possible that a call forwarding event could be detected.

### SUMMARY OF THE INVENTION

Accordingly, the present invention is directed to a method for detecting and preventing call forward that substantially obviates one or more of the problems due to limitations and disadvantages of the related art.

Call forwarding limitations inherent in the signaling network can be used to detect and prevent call forwarding. Signaling networks such as CCS7 limit the number of times that a single call can be forwarded (or “redirected”). The purpose of limiting the number of call forwarding or call redirections is to prevent a call from going into an interminable loop whereby a call is forwarded from one number (e.g., an executive's business line) to another telephone number (the executive's cellular phone) which happens to be forwarded back to the other number (i.e., the executive's business line). In such a scenario, a call to either number would “pingpong” back and forth in a continuous loop that in some instances could crash or damage the signaling network. Signaling networks such as CCS7 therefore count the number of call redirections, and when they reach the maximum number allowed by the network standard, prevent the call from being set up successfully.

The method described herein takes advantage of the unequivocal and categorical restriction on the number of call redirections in the network in order to prevent call forwarding events. Prior to processing a call, the number of call redirections in the call setup message (the Initial Answer Message or “IAM”) are set to the maximum value allowed by the network standard. If the dialed number is not call forwarded, the dialed number switch will return a message (Answer Complete Message or “ACM”) indicating that the call has been successfully set up. By contrast, if the dialed number has been call forwarded to another number, the dialed number switch will increment by one the value in the Redirection Counter, a field in the Redirection Element which is a section of the Initial Address Message. The switch will then determine that the new value exceeds the maximum number of call redirections allowed, and return a message (Release message or “REL”) with the appropriate code (release code 31, “normal unspecified”) indicating that the call could not be set up successfully even though the trunk was available and all other parameters were normal.

To eliminate the possibility of a “false positive” (a Release message sent for another reason that is unknown), another call setup message is sent, this time with the Redirection Counter set to zero indicating that no previous call forwarding has occurred. If the terminating switch then returns an ACM indicating that the call has been successfully set up, it is determined that the dialed number is indeed call forwarded to another number. At this point, the call may either be terminated, or various fraud prevention activities may then ensue. The call may also be allowed to go through, but the call detail record can be flagged as a forwarded call and the call forwarding event in a database table.

An object of the present invention is to provide a more reliable method of detecting and preventing call forwarding events that are used to defraud communications carriers and evade security controls of telephone systems such as those utilized in correctional institutions.

Another object of the present invention is to provide a method for detecting and preventing call forwarding events that does not depend on use of the Call Forwarding Indicator, an ISUP message parameter that is frequently not utilized.

Another object of the present invention is to provide a method for detecting and preventing call forwarding events that does not depend on the comparison of the dialed number with the connect number, for example, in a Call Progress Group message, an ISUP message that is very inconsistently sent by the dialed number switch.

Another object of the present invention is to provide a method of detecting and preventing call forwarding events that is independent of the type of terminating switch and how the terminating carrier and/or manufacturer has programmed that switch.

Another object of the present invention is to provide a method of detecting and preventing call forwarding events that will operate successfully even when the originating number, the dialed number, and the connect number are all interconnected to the same switch (i.e., a local call from one number to another that is forwarded to another local number).

Another object of the present invention is to provide call forwarding detection and prevention capability for switches that do not have a CCS7 signaling capability.

A further object of the present invention is to provide the ability to determine whether the dialed number trunk is available for completing the call or not prior to processing the call. This prior knowledge will enable a user of this Call Forwarding Prevention Service to eliminate the setting up of a call when the dialed number trunk is busy or otherwise unavailable (e.g., out of order). In the inmate calling environment, this capability will reduce the customer's costs associated with performing Line Identification Database (LIDB) queries to determine if the dialed number can receive a collect call.

A further object of the present invention is the reduction of switch ports and telecommunications circuits (analog line or T-1) that could very well result from eliminating the need to process calls to busy or otherwise unavailable trunks.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a call processing method for determining that call has been call forwarded comprises the steps of: sending an initial address message having a redirection counter set to the maximum allowed value; receiving a response message in response to the initial address message; and analyzing the response message to determine if the call has been forwarded.

In another aspect of the present invention, a method of processing a call comprises the steps of: determining whether a call is a forwarded call; responsive to a determination that the call is a forwarded call, preventing the call from being completed; and initiating fraud prevention activity in connection with processing the call.

In another aspect of the present invention, a method of processing a call comprises the steps of: determining whether a call is forwarded call; responsive to a determination that the call will not be completed to a dialed number, initiating fraud prevention activity in connection with processing the call; and wherein the step of initiating fraud prevention activity comprises accessing a database to obtain information indicative of whether the call represents unauthorized use of the communications network.

In another aspect of the present invention, a call processing method for terminating a forwarded call comprises the steps of: sending an initial address message having a redirection counter set to the maximum allowed value; receiving a response message in response to the initial address message; analyzing the response message to determine if the call has been forwarded; and terminating the call in response to a determination that the has been call forwarded.

In another aspect of the present invention, a method of preventing forwarded calls from connecting comprises the steps of generating an initial address message based on a call from an originating telephone number to a dialed telephone number; attempting to increment the value of a redirection counter in the initial address message when a switch attempts to forward the call to a different telephone number, the connect telephone number, wherein the connect telephone number is not the dialed telephone number; preventing the call from being connected to the connect telephone number if the attempt to increment the value of the redirection counter fails.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a simplified block diagram of a portion of a telecommunications network, including signaling network components, suitable for processing forwarded calls in accordance with the present invention.

FIG. 2 is an illustrative diagram showing the sequence and the logic of messages that determine whether a call has been forwarded or not.

FIG. 3 is a simplified block diagram that depicts one possible network architecture for providing a call forwarding prevention system without the use of a telecommunications switch through which the call passes.

### DETAILED DESCRIPTION OF THE PREFERRED EMBODIMENTS

Reference will now be made in detail to a preferred embodiment of the present invention, example of which is illustrated in the accompanying drawings. A path through an illustrative communications network of a typical forwarded call is described with reference to the drawings.

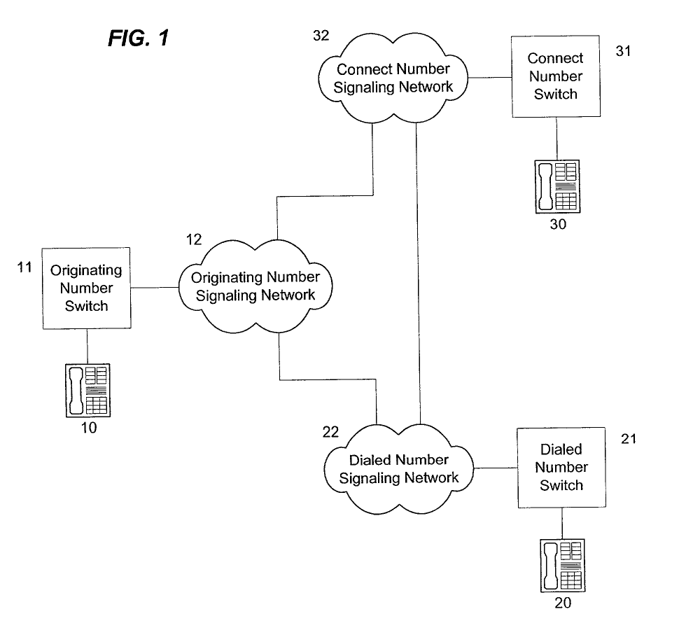

As shown in FIG. 1, originating station 10 is the telephone station that originates the call. Switch 11 is the switch to which the originating station 10 is connected. Signaling network 12 is the network associated with the originating switch 11. Station 20 is the telephone station whose number is dialed by the originating station 10. Switch 21 is the switch to which the dialed number station is connected. Signaling network 22 is the signaling network of the dialed number switch 21. Telephone station 30 is the telephone station to which the call is forwarded (connect number). Switch 31 is the switch to which the connect number station is connected. Signaling network 32 is the signaling network of the connect number switch 31.

FIG. 1 is used to illustrate the signaling which occurs to set up a forwarded call. FIG. 1 shows a portion—particularly the signaling portion—of an exemplary communications network at telephone station 20 that has subscribed to a call forwarding service. The network includes telephone stations 10, the originating station (i.e., the telephone that originates the call); station 20, the dialed number station (i.e., the station with which station 10, the originating station wishes to speak); and station 30, the station to which station 20 has been call forwarded. The network also includes switches 11, 21, and 31, to which stations 10, 20, and 30 are respectively connected, and these switches' respective signaling networks 12, 22, and 32. For the purposes of explanation, it is assumed that a calling party at a telephone station 10 desires to place a call to a party at a telephone station 20, and that the party at station 20 wishes to have all calls forwarded to telephone station 30.

One skilled in the art will readily appreciate that the principles of the invention are not limited by the architecture of the switching network used, but rather are applicable to any switching system in which the number of call redirections (call forwarding events) is captured and aggregated when a call, or a leg of a call, is being set up. For example, switch 11 could be a Local Exchange Carrier (LEC) switch, an Inter-Exchange Carrier (IXC) switch, or the like. The invention is even capable of detecting and preventing a call forwarding event even when a single switch is used to process the call (the originating, dialed, and connect numbers are all directly connected to the same switch). Switches 11, 21 and 31 communicate with the other switches in the call path by exchanging call handling messages via a data network called a Common Channel Signaling (CCS) network. The CCS network is a packet switching network having a plurality of interconnected nodes called Signal Transfer Points (STPs) that are used to exchange call handling messages between switches according to a specific protocol, such as CCS7. However, for the sake of simplicity, the constituent elements of the signaling network are not expressly shown. The features and functionality of an STP are described in the book Engineering and Operations in the Bell System, Second Edition, AT&T Bell Laboratories, 1992, pp. 292-294.

The invention will be described herein in the context of messages using the Integrated Services Digital Network (ISDN) User Part (ISUP) protocol. ISUP is an interoffice protocol for circuit-related functions that interworks with Q.931 signaling. ISUP supports calls between subscribers for basic bearer services and supplementary services (such as Call Forward Busy (CFB), Call Forward No Reply (CFNR), and Call Forward Unconditional (CFU)) for voice and non-voice applications in ISDN. However, ISUP also supports calls between non-ISDN subscribers. The ISUP message is generated and interpreted by the switches of the CCS network and is carried as the user data in the MTP (Message Transfer Part) or SCCP (Signaling Connection Control Part) message. Referring to FIG. 1, switches 11 and 31 communicate with telephone stations 10 and 30, respectively, using a conventional signaling arrangement for the control of circuit-switched calls, illustratively Q.931 signaling. ISUP, with the use of the CCS network, extends Q.931 (which is a point-to-point network access protocol) over a store-and-forward message switching network. While the invention is discussed in the context of CCS7, ISUP, and Q.931 signaling, one skilled in the art will readily appreciate that the principles of the invention are not limited by the type of network signaling used, but rather are applicable to any switching system in which the number of call redirections (call forwarding events) is captured and aggregated when a call, or a leg of a call, is being set up.

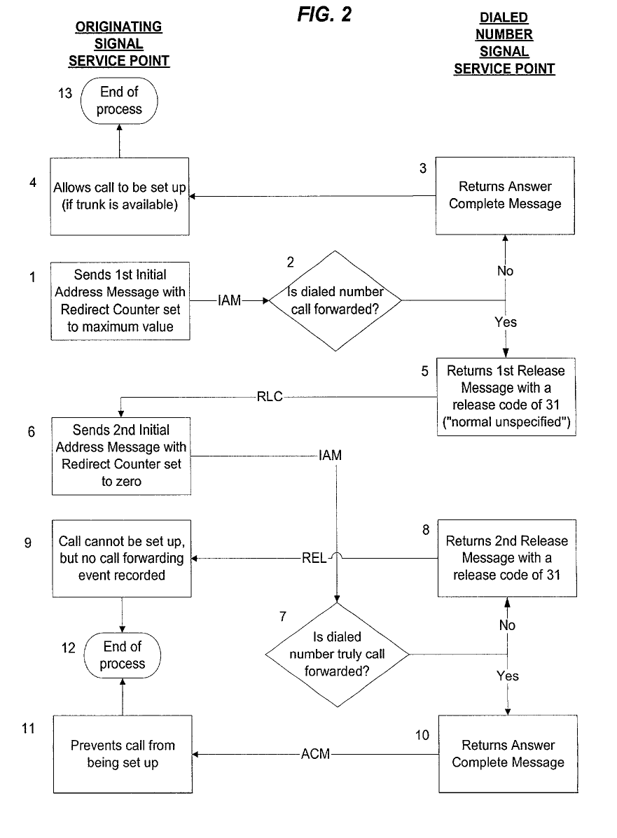

FIG. 2 shows exemplary signaling and decision logic used to detect a forwarded call. When a call is initiated from telephone station 10 to telephone station 20, switch 11 collects dialed digits from telephone station 10 using well-known stimulus signaling methods (typically DTMF tones). Switch 11 uses the received dialed number to generate and transmit an ISUP Initial Address Message (“IAM”) to switch 21. Switch 21 recognizes that telephone station 20 has activated the call forwarding feature. Rather than setting up the call with telephone station 20, switch 21 will attempt to create an IAM message for transmission to switch 31 via signaling networks 22 and 32 to effect the call forwarding service, Step 1. If the dialed number is not call forwarded, determined at Step 2, switch 21 will increment the value in the Redirection Counter parameter (field code hex 13) by one to count the call forwarding event and sends the IAM to switch 31, Step 3. Switch 31 will then send an Answer Complete Message (ACM) to switch 11, the originating switch, to indicate that the call has been set up successfully, Step 3 and Step 4.

By contrast, if the dialed number is call forwarded, when switch 21 attempts to increment the value in the Redirection Counter in the IAM sent by the originating switch by one, it will be unable to do so as this value, by design, already equals the maximum value allowed by the network signaling standard (CCS7 in our example above). Switch 21 will be unable to create an LAM to set up the call to switch 31. It will therefore return a Release message (REL) to switch 11 indicating that the call could not be set up even though the dialed number trunk was available, Step 5. Each Release message contains a Cause Indicator or release code that indicates why the call could not be set up (e.g., dialed number was busy, out of order, an invalid number, etc.). In the event where the call could not be set up because the Redirection Counter in the IAM message to the connect number switch exceeded the maximum allowed value, the Release message under the CCS7 standard will contain a Cause Indicator or release code of 31 which is defined as “normal unspecified.” That is, the trunk is available, and all other parameters are normal; however, the call still cannot be set up correctly.

Upon receipt of this Release message, switch 11 will ensure against any possibility of a “false positive,” that is, the possibility that switch 21 sent a Release message with the aforementioned release code (RLC) for some other unknown reason. To do so, switch 11 will send switch 21 a second IAM, Step 6, this time setting the Redirection Counter preferably to zero indicating that no call forwarding has yet occurred. This time, if the dialed number is forwarded, Step 7, switch 21 will be able to create an IAM to switch 31, because it will be able to increment the value of the Redirection Counter contained in the IAM from switch 21 by one. Upon receipt of this IAM from switch 21, if this call is forwarded, switch 31 will send an Answer Complete Message back to switch 11 indicating that the call has been set up successfully. As long as the Redirection Counter in the second IAM is set to less than a maximum allowed value, and is preferably set to zero, the switch 21 will be able to increment the Redirection Counter and will be able to set up the IAM to switch 31. The maximum allowed value is preferably the maximum allowed value assigned by the SS7 Standard. However, the maximum allowed value may be any predetermined integer value.

At this point, switch 11 will have determined that the call has been call forwarded from switch 21 to switch 31. The call forwarding event is apparent because when the call could not be forwarded one more time (i.e., the Redirection Counter in the original IAM was set to the maximum value), the call set up failed. However, when the redirection counter in the second IAM was set to zero, the call was set up without difficulty clearly indicating that the reason for the initial call set up failure was the inability to redirect the call one more time, Step 10. If the response to the second IAM is another Release Message with a release code of 31, then the assumption would be that the dialed number was not call forwarded, but rather some other network problem prevented the call from being set up successfully, as shown in Steps 8 and 9.

Having described how to detect that a call has been forwarded, various ways in which the information can be used to minimize fraud will now be described, e.g. Step 11. First, the information that a call has been forwarded can be used to determine whether to complete the call. Calls to numbers that are determined to be call forwarded can simply be terminated. As used herein, “terminating” a call refers to preventing a normal voice path (or data path for facsimile calls and other data transmissions), and includes blocking of the call before the path is established or tearing down the call if the path has already been established. Switch 1 (FIG. 1) can transmit a Release call supervision message to the other switches involved in the call. This type of processing may be appropriate where call forwarding simply is not allowed for the call. One example where such processing would be appropriate is the limited telephone service available to inmates in correctional facilities—inmates are allowed to call only selected telephone numbers. By restricting the use of call forwarding entirely, inmates are prevented from placing unauthorized calls via the call forwarding mechanism which would have been blocked had the call been directly dialed to that destination. Because calls placed from cellular or other radio-based telephones are subject to high fraud, including fraud committed via call forwarding, it may also be appropriate to terminate all cellular calls connected to a number other than the dialed number.

In another embodiment of the invention, upon detection of a call forwarding event, switch 1 routes the call to an attended operator position or other customer service attendant. The attendant may then question the caller to obtain further information demonstrating the caller's right to complete the call. The attendant then determines whether to complete or terminate the call.

In still another embodiment of the invention, forwarded calls are flagged for further investigation or processing. Forwarded calls flagged for further investigation as described above can be processed according to the call forwarding history of the dialed number. That is, forwarded calls are checked against call detail records stored in a database to determine how often calls to that dialed number have been forwarded within some specified period of time. The database, which may be a network control point (NCP) would store records having at least the dialed number and an indication of whether the call to the dialed number was forwarded to another number. The records preferably also would include the date and time of the call, the ANI (“Automatic Number Identification,” i.e., the telephone number) of the originating telephone station, and the connect number. In operation, call processing would proceed as described above until switch 11 determines that the call is a forwarded call. Upon detecting call forwarding, switch 11 queries the database with a message which includes the dialed number, a call forward indicator, and preferably the ANI of the originating telephone station, the connect number, and the date and time of the call. The database includes a processor under the control of suitable programming which, in response to the call forwarding indicator, compares the dialed number with the dialed number of the call detail records stored in the database. The processor of the database counts the number of occurrences (matches) in which the dialed number in the message received from switch 11 matches a record in the database having a dialed number and a call forwarding indicator. If the number of occurrences exceeds a predetermined threshold (as specified in fraud prevention software installed in the database processor), the database returns a message to switch 11 instructing the switch to terminate the call or initiate other fraud prevention activities. The information provided to the database in the original message from switch 1 is added as a record to the database as a call detail record. The database can be designed to automatically discard old call detail records on a rolling basis as new call detail records are added. The database may be dedicated to monitoring call forwarding fraud, but preferably is part of another system or has other functions and uses so as to make the system more efficient.

While the invention has been discussed in the context of wired telephone service, the principles of the invention are equally applicable to wireless telephone service, such as calls originating from a cellular telephone. The call forwarding fraud prevention techniques of the invention may also be useful where a caller is directly connected to an IXC, such as through an operator position. For example, the principles described herein are applicable to calls billed to a calling card or credit card, and to calls placed (completed) by an attendant on the caller's behalf. In this regard, the principles of the invention can be utilized to provide an attendant with an indication that a given call has been forwarded to the attendant. Such an indication will enable the attendant to recognize the call as a forwarded call and refuse to complete the call.

One skilled in the art will readily appreciate that the principles of the invention are not limited by the architecture of the switching network. Moreover, an alternative embodiment of the invention does not require the use of any telecommunications switch to create, send, receive and analyze the messages in the Common Channel Signaling network. Rather, a computer server containing CCS7 processing boards (such as those offered commercially by Natural Microsystems Corporation) can be used to create, send, receive and analyze messages from switches and various elements of the signaling network.

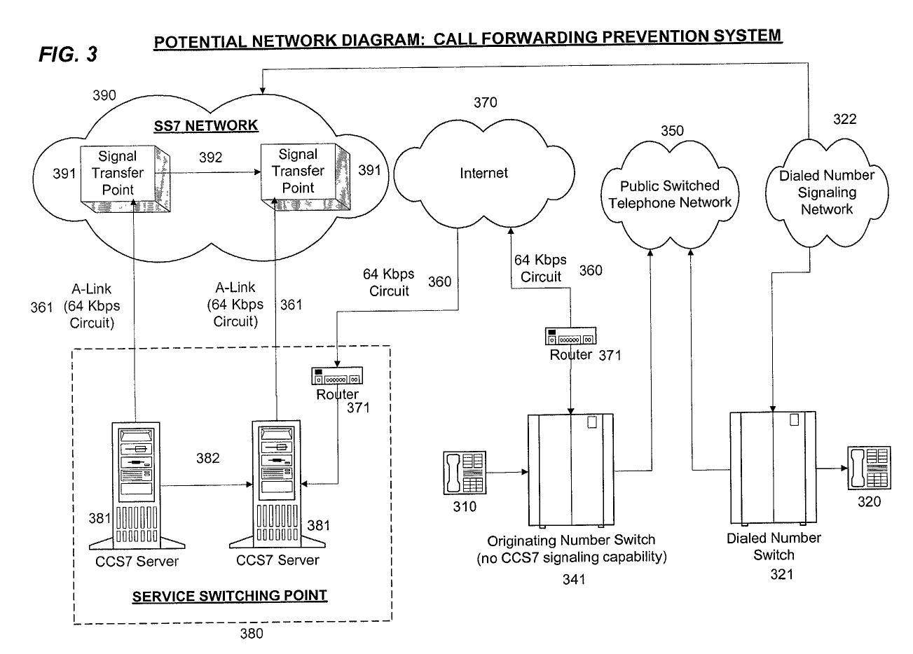

FIG. 3 illustrates how such a network architecture might be designed. Similar to the preferred embodiment described above, telephone station 310, connected with switch 341, a telecommunications switch without any CCS7 signaling capability. Station 310 wishes to call station 320, connected to switch 321. However, in this embodiment, switch 341 is not directly connected to the out-of-band network signaling network 390 (the CCS7 network, for example). Rather, switch 341 sends the information required to construct the messages utilized in the signaling network via a TCP/IP connection—typically the Internet 370—to a redundant pair of servers 381, which act as Service Switching Points (SSP) 380. Routers 371 may be used to set up the TCP/IP connection. These servers 381 are connected to the signaling network 390 via A-Links 361, telecommunications circuits that connect SSPs with Signal Transfer Points (“STP”) 391, which may be connected to one another via a C-Link 392. These servers 381 also receive messages from the signaling network 392, analyze them, and return responses to the queries originally sent over the TCP/IP connection, e.g., the Internet 370, by the originating switch 341.

Referring to FIG. 3, upon capturing the number dialed by station 310, switch 341 will send a message (a “New Call Query”) over the Internet 370 to the CCS7 Servers 381. Among other items, said message will indicate to the CCS7 Servers the dialed telephone number. CCS7 servers 381 are linked by an F-Link 382.

Upon receiving said New Call Query message, CCS7 Servers 381 may first check a table of customer and switch codes to validate that A) the message is from an approved switch (e.g., a carrier who is paying for a call forwarding prevention service) and B) that their account status is “Active.” Once the customer and switch have been validated, the CCS7 Server 381 will send an Initial Address Message (IAM) with the Redirection Counter set to the maximum value allowed by the signaling standard as described above. The remainder of the process is as has been described above in the detailed description of the preferred embodiment of the invention. Upon completion of this process, the CCS7 Server 381 sends a response (New Call Response) to switch 341 indicating whether a call has been forwarded or not.

In addition to offering the call forwarding detection and prevention capabilities, this embodiment offers several other benefits. The telecommunications hardware and services (primarily the A-Links 361 and the carrier routes 360 and routers 371) required for a CCS7-compliant switch are very expensive. The network architecture depicted in FIG. 3 creates the possibility of a centralized call forwarding prevention service that provides services to a multiplicity of switches via the Internet where the implementation of such a service in each and every switch would be uneconomical.

A secondary benefit of this embodiment of the invention is that the CCS7 Servers 381 can provide other information from the signaling network to the interconnected switches. For example, referring to FIG. 3, switch 321 may return a Release message to the CCS7 Server 381 with a release code other than the one that suggests a call forwarding event (code 31 in the CCS7 standard). For example, the dialed number may be busy, it may be out of order, or the number itself may be invalid. Even when the dialed number is not call forwarded, the information conveyed by the release code may still be beneficial to the switch that subscribes to the call forwarding prevention service provide by the CCS7 Servers 381. For example, if station 320 is busy or otherwise unavailable, the CCS7 Servers 381 can return this information in responding to a query from switch 341. This information eliminates the need for a switch to process the call from station 310 to station 320 since the information is provided before the call is set up. The elimination of calls to unavailable dialed numbers may reduce the number of “dips” (i.e., queries) that switch 321 must make into other databases such as the Line Identification Database (LIDB) for call validation or a Local Number Portability database (LNP) for call routing purposes. In addition, the elimination of unnecessary calls may decrease the communication carrier's port requirements (i.e., the fewer the calls, the smaller the switch needed to be to process those calls) and/or telecommunication circuit requirements.

A third advantage of this embodiment of the invention is that the detection and prevention of call forwarding will work regardless of how the call is routed through the network, be it through multiple LEC switches, a combination of LEC and IXC switches, or even through a single LEC switch itself (in the event the originating number, the dialed number, and the connect number are all connected to a single LEC switch). In essence, the originating switch sends a data message (the New Call Query) over the Internet 370 to the CCS7 Servers 381 and suspends the processing of the call until a response to its query is received. The CCS7 Servers 381 then go through the process described above of setting up the call (i.e., sending an IAM) over the signaling network with the Redirection Counter set at the maximum value. The Servers 381 can send this message to any switch connected to the signaling network including the switch from which the call originated.

An advantage of this embodiment of the invention is that it simplifies the implementing a call forwarding detection and prevention service. The switches for which one wishes to use a call forwarding service as described above do not have to have their software that provides for call set ups to be reprogrammed in order to perform the various processes described above (some of which may not be possible in some manufacturers' switches). Rather these switches simply need to suspend the processing of the call until a query can be sent to and a response received (typically in one to two seconds) from the CCS7 Servers 381.

Accordingly, the invention offers communication carriers a more reliable solution for detecting and preventing call forwarding events. The detection and prevention of call forwarding events enables carriers to reduce fraud as well as attempts to evade security controls inherent to certain telephone networks (e.g., inmate calling systems). The invention offers several clear advantages over existing methods of detecting and preventing call forwarding events, namely that it:

(1) Works reliably regardless of switching architectures, switch manufacturers, or implementation of signaling protocols;

(2) Does not depend on the comparison of the dialed number and the connect number, for example, from a Call Progress Group message, a method that will frequently fail due to the inconsistent use of that message; and

(3) Can be used to identify call forwarding events regardless of the network architecture and even when the originating, dialed, and connect numbers are all connected to the same switch.

Moreover, the invention provides a call forwarding detection and prevention method that can be used with switches that do not have an out-of-band signaling (e.g., CCS7 ) capability and reduces costly call validation and routing database queries (LIDB and LNP) as well as switch port and telecommunications circuit requirements.

It will be apparent to those skilled in the art that various modifications and variation can be made in the present invention without departing from the spirit or scope of the invention. For example, while the invention has been described in the context of voice and data call, the principles of the invention are equally applicable to multimedia calls, such as video telephone calls. Thus, it is intended that the present invention cover the modifications and variations of this invention provided they come within the scope of the appended claims and their legal equivalents, rather than by the examples given.

We claim:

1. A call processing method for determining that a call has been call forwarded comprising:
sending an initial address message having a redirection counter set to a maximum allowed value;
receiving a response message in response to the initial address message; and
analyzing the response message to determine if the call has been forwarded.

2. The call processing method of claim 1, further comprising initiating fraud prevention activity.

3. The call processing method of claim 2 wherein the fraud prevention activity includes terminating the call.

4. The call processing method of claim 1, further comprising accessing a database to obtain information indicative of whether the call represents unauthorized use of a communications network.

5. The call processing method of claim 1, wherein the initial address message is an Integrated Services Digital Network (ISDN) User Part (ISUP) protocol Initial Address Message.

6. The call processing method of claim 1, further comprising sending another initial address message having another redirection counter set to a predetermined value if it is undetermined whether the call has been forwarded as a result of the analyzing step.

7. The call processing method of claim 6, wherein the predetermined value is zero.

8. A method of processing a call, comprising:
determining whether the call is a forwarded call;
responsive to a determination that the call is a forwarded call, preventing the call from being completed; and
initiating fraud prevention activity.

9. The method of processing a call of claim 8, wherein initiating fraud prevention activity comprises:
determining whether a dialed telephone number is subject to a call restriction;
determining a telephone station to which the call will be connected;
testing a second telephone number associated with the telephone station; and
terminating the call if the second telephone number is subject to the call restriction.

10. The method of processing a call of claim 8, wherein said step of determining whether a call has been forwarded does not utilize a telecommunications switch through which the forwarded call passes.

11. The method of processing a call of claim 8, wherein determining whether a call is a forwarded call comprises:
sending an initial address message having a redirection counter set to a maximum allowed value;
receiving a response message in response to the initial address message; and
analyzing the response message to determine if the call has been forwarded.

12. The call processing method of claim 11, further comprising sending another initial address message having another redirection counter set to a predetermined value if it is undetermined whether the call has been forwarded as a result of the analyzing step.

13. The call processing method of claim 12, wherein the predetermined value is zero.

14. A method of processing a call, comprising:
determining whether a call is forwarded call; and
responsive to a determination that the call is a forwarded, initiating fraud prevention activity in connection with processing the call,
wherein initiating fraud prevention activity comprises accessing a database to obtain information indicative of whether the call represents unauthorized use of a communications network.

15. The method of processing a call of claim 14, wherein determining whether a call is a forwarded call includes determining whether the call will be completed to a dialed number.

16. The method of processing a call of claim 14, wherein determining whether a call is a forwarded call comprises:
sending an initial address message having a redirection counter set to a predetermined value;
receiving a response message in response to the initial address message indicating whether the redirection counter was incremented; and
analyzing the response message to determine if the call has been forwarded.

17. The method of processing a call of claim 16, wherein the initial address message is an Integrated Services Digital Network (ISDN) User Part (ISUP) protocol Initial Address Message.

18. The method of processing a call of claim 16, further comprising sending another initial address message having another redirection counter set to another predetermined value if it is undetermined whether the call has been forwarded as a result of the analyzing step.

19. The method of processing a call of claim 18, wherein the another predetermined value is zero.

20. A call processing method for terminating a forwarded call, comprising:
sending an initial address message having a redirection counter set to a maximum allowed value;
receiving a response message in response to the initial address message;
analyzing the response message to determine if the call has been forwarded; and
terminating the call in response to a determination that the call has been forwarded.

21. The call processing method of claim 20, wherein the initial address message is an Integrated Services Digital Network (ISDN) User Part (ISUP) protocol Initial Address Message.

22. The call processing method of claim 20, further comprising sending another initial address message having another redirection counter set to a predetermined value if it is undetermined whether the call has been forwarded as a result of the analyzing step.

23. The call processing method of claim 22, wherein the predetermined value is zero.

24. A method of preventing forwarded calls from connecting, comprising:
generating an initial address message based on a first telephone number associated with a call from a first telephone station, the initial address message having a redirection counter set to a predetermined value;
attempting to increment a value of the redirection counter when a switch attempts to forward the call to a second telephone number associated with a respective telephone station, wherein the second telephone number is not a dialed telephone number;
preventing the call from being connected to the second telephone station if the attempt to increment the value of the redirection counter fails; and
connecting the call to the second telephone station if the attempt to increment the value of the redirection counter is successful.

25. The method of preventing forwarded calls from connecting of claim 24, further comprising generating a release message indicating that the call could not be set up if the call is prevented from being connected to the second telephone station.

26. The method of preventing forwarded calls from connecting of claim 24, further comprising initiating fraud prevention activity if the attempt to increment the value of the redirection counter fails.

27. The method of preventing forwarded calls from connecting of claim 24, further comprising setting the value of the redirection counter to a maximum allowed value when the initial address message is generated.

28. The method of preventing forwarded calls from connecting of claim 24, wherein the initial address message is an Integrated Services Digital Network (ISDN) User Part (ISUP) protocol Initial Address Message.

29. The method of preventing forwarded calls from connecting of claim 25, further comprising generating another initial address message associated with the call if the release message is generated.

30. The method of preventing forwarded calls from connecting of claim 25, further comprising generating another initial address message associated with the call and having a redirection counter set to another predetermined value, if the release message is generated.

31. The method of preventing forwarded calls from connecting of claim 30, wherein the another predetermined value is zero.
